(19) United States
(12) Patent Application Publication
(10) Pub. No.: US 2024/0242365 A1
(43) Pub. Date: Jul. 18, 2024

(54) METHOD AND APPARATUS WITH IMAGE PROCESSING

(71) Applicant: SAMSUNG ELECTRONICS CO., LTD., Suwon-si (KR)

(72) Inventors: Yi ZHOU, Beijing (CN); Seungin PARK, Suwon-si (KR); Byung In YOO, Suwon-si (KR); Sangil JUNG, Suwon-si (KR); Hui ZHANG, Beijing (CN)

(73) Assignee: SAMSUNG ELECTRONICS CO., LTD., Suwon-si (KR)

(21) Appl. No.: 18/415,839

(22) Filed: Jan. 18, 2024

(30) Foreign Application Priority Data
Jan. 18, 2023 (CN) 202310084221.0
Nov. 15, 2023 (KR) 10-2023-0158018

(51) Int. Cl. G06T 7/50; G06V 10/44; G06V 10/74; G06V 10/80

(52) U.S. Cl. CPC G06T 7/50; G06V 10/44; G06V 10/761; G06V 10/806

(57) ABSTRACT

A processor-implemented method including generating a depth-aware feature of an image dependent on image features extracted from image data of the image and generating image data, representing information corresponding to one or more segmentations of the image, based on the depth-aware feature and a depth-aware representation, the depth-aware representation being depth-related information and visual-related information for the image.

### CROSS-REFERENCE TO RELATED APPLICATIONS

This application claims the benefit under 35 USC § 119(a) of Chinese Patent Application No. 202310084221.0 filed on Jan. 18, 2023, in the China National Intellectual Property Administration, and Korean Patent Application No. 10-2023-0158018 filed on Nov. 15, 2023, in the Korean Intellectual Property Office, the entire disclosures of which are incorporated herein by reference for all purposes.

### BACKGROUND

### 1. Field

The following description relates to a method and apparatus with image processing.

### 2. Description of Related Art

Image panoptic segmentation (IPS) may refer to a typical process of assigning a label to each pixel of a two-dimensional (2D) image. Image content may generally be divided into two categories where one category are items that represents uncountable objects that may not need to be individually distinguished, which may be referred to as “stuff,” such as, for example, grass, sky, architecture, and the like, and the second category include items that represent countable objects that may need to be individually distinguished, which maybe referred to as “things”, such as, for example, people, cars, and the like. This panoptic segmentation may be a combination of semantic segmentation and instance segmentation, where, for example, pixels included in stuff may require the prediction of semantic labels, and pixels included in a thing may require the prediction of instance labels.

Video panoptic segmentation (VPS) may be an extension of IPS in a time domain. In addition to performing panoptic segmentation on each image, VPS can also integrate features that may perform object tracking and assign a same label to pixels belonging to the same instance in different images.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, here is provided a processor-implemented method including generating a depth-aware feature of an image dependent on image features extracted from image data of the image and generating image data, representing information corresponding to one or more segmentations of the image, based on the depth-aware feature and a depth-aware representation, the depth-aware representation being depth-related information and visual-related information for the image.

The generating of the depth-aware feature of the image may include generating a visual feature and a depth feature of the image based on the image features and generating the depth-aware feature by fusing the visual feature and the depth feature.

The generating of the depth-aware feature by fusing the visual feature and the depth feature may include generating a first visual feature and a first depth feature by performing a convolution operation on the visual feature and the depth feature, respectively, generating a first feature by fusing the first visual feature and the first depth feature, generating a second feature by fusing the first depth feature and the first feature, and generating the depth-aware feature by sequentially performing feature concatenation and feature transformation on the second feature and the visual feature.

The generating of the depth-aware feature by sequentially performing the feature concatenation and the feature transformation may include generating a third feature by sequentially performing feature concatenation and feature transformation on the second feature and the visual feature, generating a fourth feature by reshaping a dimension of the depth feature, generating a first depth position feature by fusing the fourth feature and a depth-related position embedding, and generating the depth-aware feature by fusing the third feature and the first depth position feature.

The generating of the image data may include generating a refined depth-aware representation by refining the depth-aware representation, generating depth prediction information of the segmentations based on the refined depth-aware representation and the depth-aware feature, generating an enhanced depth-aware feature by enhancing the depth-aware feature, and generating, as the image data, mask prediction information and category prediction information respectfully dependent on the refined depth-aware representation and the enhanced depth-aware feature.

The generating of the refined depth-aware representation by refining the depth-aware representation may include generating a first depth-aware representation by processing the depth-aware representation through a first attention network, generating a second depth-aware representation by fusing the depth-aware representation and the first depth-aware representation and normalizing a feature-fused representation obtained by the fusing, generating a third depth-aware representation by processing the depth-aware feature and he second depth-aware representation through a second attention network, generating a fourth depth-aware representation by fusing the second depth-aware representation and the third depth-aware representation and normalizing a feature-fused representation obtained by the fusing, and generating the refined depth-aware representation based on the fourth depth-aware representation using a feedforward network.

The generating of the depth prediction information of the segmentations may include generating a fifth feature by performing a linear operation on the refined depth-aware representation and obtaining a sixth feature by performing a convolution operation on the depth-aware feature, generating a seventh feature by fusing the fifth feature and the sixth feature, generating an eighth feature by fusing the seventh feature and the fifth feature, generating a ninth feature by fusing the eighth feature and the sixth feature, and generating the depth prediction information based on the ninth feature using a depth estimation network.

The generating of the depth prediction information based on the ninth feature may include generating a feature weight corresponding to the ninth feature by performing pooling on the ninth feature and performing a linear operation on a pooled ninth feature obtained by the pooling and generating the depth prediction information by performing a linear operation on the ninth feature using the feature weight.

The generating of the depth prediction information of the segmentations may include generating the depth prediction information and enhanced depth-related information of the segmentations based on the refined depth-aware representation and the depth-aware feature, and the generating of the enhanced depth-aware feature may include generating a tenth feature by performing a convolution operation on the depth-aware feature and obtaining an 11th feature by performing a convolution operation on the enhanced depth-related information, generating a 12th feature by fusing the tenth feature and the 11th feature, generating a 13th feature by fusing the 11th feature and the 12th feature, and generating the enhanced depth-aware feature by sequentially performing feature concatenation and feature transformation on the 13th feature and the depth-aware feature.

The generating of the enhanced depth-aware feature by sequentially performing the feature concatenation and the feature transformation on the 13th feature and the depth-aware feature may include generating a 14th feature by sequentially performing feature concatenation and feature transformation on the 13th feature and the depth-aware feature, generating a 15th feature by reshaping a dimension of the enhanced depth-related information, generating a second depth position feature by fusing the 15th feature and a depth-related position embedding, and generating the enhanced depth-aware feature by fusing the 14th feature and the second depth position feature.

The generating of the mask prediction information and the category prediction information of the segmentations may include generating the category prediction information based on the refined depth-aware representation using a first linear layer and generating a 16th feature associated with a mask and generating the mask prediction information by fusing the 16th feature and the enhanced depth-aware feature, based on the refined depth-aware representation, using a second linear layer.

Where the image is a current frame image of a video to be processed, and wherein the method may include generating a refined depth-aware representation of a previous frame image of the current frame image and performing similarity matching between a refined depth-aware representation of the current frame image and the refined depth-aware representation of the previous frame image, such that a same instance of the current frame image and the previous frame image have a unified indicator.

Where the image is a current frame image of a video to be processed, the method may include generating a refined depth-aware representation of a previous frame image of the current frame image and processing, through a third attention network, a refined depth-aware representation of the current frame image and the refined depth-aware representation of the previous frame image, generating a time-domain refined depth-aware representation of a time-domain context, and determining time-domain refined depth-aware representation as the refined depth-aware representation of the current frame image.

One vector of the depth-aware representation may represent one object in the image.

In a general aspect, here is provided a non-transitory computer-readable storage medium storing instructions that, when executed by a processor, cause the processor to perform the method.

In a general aspect, here is provided an electronic device including processors configured to execute instructions and a memory storing the instructions, wherein execution of the instructions configures the processors to generate a depth-aware feature of an image dependent on image features extracted from image data of the image and generate image data, representing information corresponding to one or more segmentations of the image, based on the depth-aware feature and a depth-aware representation, and the depth-aware representation includes depth-related information and visual-related information for the image.

The processors may be further configured to, when generating the depth-aware feature generate a visual feature and a depth feature of the image based on the image features and generate the depth-aware feature by fusing the visual feature and the depth feature.

The processors may be further configured to, when obtaining the depth-aware feature by fusing the visual feature and the depth feature generate a first visual feature and a first depth feature by performing a convolution operation on the visual feature and the depth feature, respectively, generate a first feature by fusing the first visual feature and the first depth feature, generate a second feature by fusing the first depth feature and the first feature, and generate the depth-aware feature by sequentially performing feature concatenation and feature transformation on the second feature and the visual feature.

The processors may be further configured to, when generating the depth-aware feature generate a third feature by sequentially performing feature concatenation and feature transformation on the second feature and the visual feature, generate a fourth feature by reshaping a dimension of the depth feature, generate a first depth position feature by fusing the fourth feature and a depth-related position embedding, and generate the depth-aware feature by fusing the third feature and the first depth position feature.

The processors may be further configured to, when generating the segmentations generate a refined depth-aware representation by refining the depth-aware representation, generate depth prediction information of the segmentations based on the refined depth-aware representation and the depth-aware feature, generate an enhanced depth-aware feature by enhancing the depth-aware feature, and generate mask prediction information and category prediction information of the segmentations based on the refined depth-aware representation and the enhanced depth-aware feature.

### BRIEF DESCRIPTION OF THE DRAWINGS

FIG. 1 illustrates an example image segmentation according to one or more embodiments.

FIG. 2 illustrates an example depth-aware video panoptic segmentation (DVPS) according to one or more embodiments.

FIG. 3 illustrates an example image processing method according to one or more embodiments.

FIG. 4 illustrates an example DVPS algorithm according to one or more embodiments.

FIG. 5 illustrates an example depth-aware feature generation model according to one or more embodiments.

FIG. 6 illustrates an example depth estimator according to one or more embodiments.

FIG. 7 illustrates an example depth-aware feature model according to one or more embodiments.

FIG. 8 illustrates an example depth-aware decoder according to one or more embodiments.

FIG. 9 illustrates an example refinement model according to one or more embodiments.

FIG. 10 illustrates an example depth estimation head according to one or more embodiments.

FIG. 11 illustrates an example segmentation estimation head according to one or more embodiments.

FIG. 12 illustrates an example depth enhancement model according to one or more embodiments.

FIG. 13 illustrates an example depth enhancement model according to one or more embodiments.

FIG. 14 illustrates an example image processing device in a hardware operating environment according to one or more embodiments.

FIG. 15 illustrates an example electronic device according to one or more embodiments.

Throughout the drawings and the detailed description, unless otherwise described or provided, the same drawing reference numerals may be understood to refer to the same, or like, elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

The term “panoptic object” used herein may refer to stuff content and thing content. In the case of the stuff content (e.g., sky, grass, etc.), a panoptic object may consist of all pixels of the same type in an image (e.g., a “sky panoptic object” consists of all pixels belonging to a “sky” category). In the case of the thing content (e.g., a pedestrian, a car, etc.), a panoptic object may consist of each entity or object.

Depth-aware VPS (DVPS) may be an extension of typical VPS from a 2D process to a three-dimensional (3D) understanding. In addition to maintaining a typical VPS (i.e., video panoptic object segmentation) functionality, monocular video depth estimation (i.e., estimating a depth value for each pixel in a video) may be applied to DVPS. Including VPS and monocular video depth estimation may be considered a multitask. However, a typical DVPS method may not have high accuracy in predicted segmentation results.

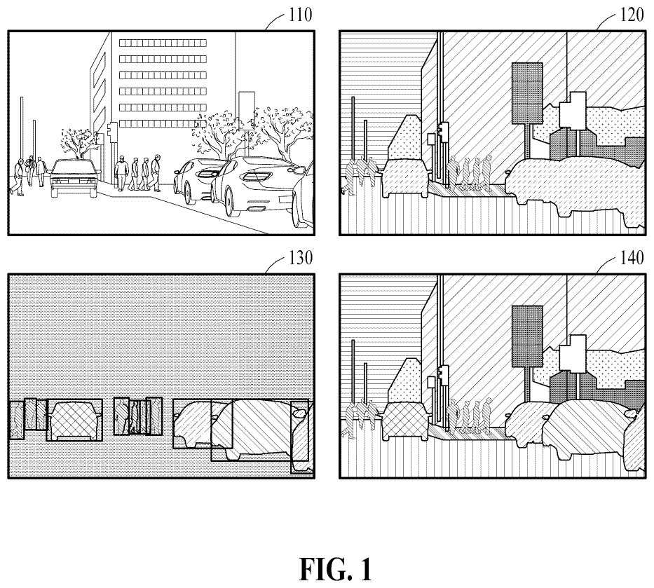

FIG. 1 illustrates an example image segmentation according to one or more embodiments.

Referring to FIG. 1, in a non-limiting example, reference numeral 110 may indicate a frame of an image to be segmented, and reference numeral 120 may indicate a semantic segmentation result in which pixels of the same color belong to the same category. Because there is typically no need to distinguish between different instances in the semantic segmentation result, different things (e.g.,) people may belong to the same category. In addition, reference numeral 130 may indicate an instance segmentation result obtained by instance segmentation that focuses only on pixels of a thing category. In this case, different objects belonging to the same category may need to be distinguished, for example, different label values may need to be assigned to different things (e.g., people or vehicles) which are illustrated in different cross-hatching patterns. In addition, reference numeral 140 may indicate a panoptic segmentation result obtained from panoptic segmentation that is considered a combination of two tasks-semantic segmentation and instance segmentation, and predicts semantic labels for pixels belonging to stuff and predicts instance labels for pixels belonging to a thing.

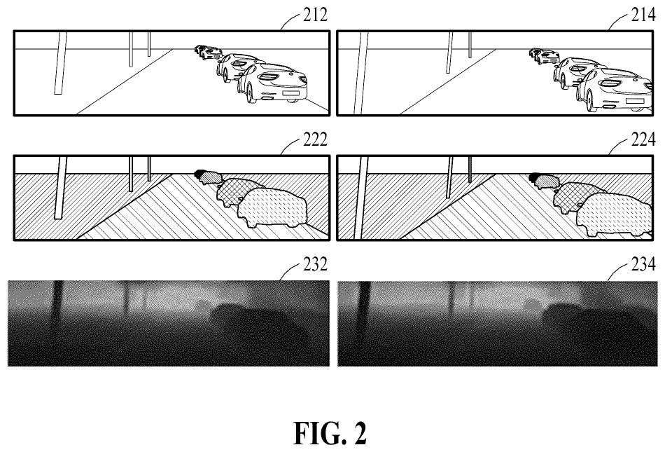

FIG. 2 illustrates an example depth-aware video panoptic segmentation (DVPS) according to one or more embodiments.

Referring to FIG. 2, in a non-limiting example, reference numerals 212 and 214 may indicate two frames from before and after image segmentation. Reference numerals 222 and 224 may indicate panoptic segmentation results obtained from the two frames 212 and 214, respectively, and it may be verified that the same color is assigned to pixels belonging to the same instance in the two frames 212 and 214, and thus corresponding instances between the frames 212 and 214 are correctly identified. Reference numerals 232 and 234 may indicate depth estimation results obtained from the two frames 212 and 214, respectively, in which dark pixels indicate smaller depth values, that is, closer to a camera.

DVPS may be typically performed using a “PolyphonicFormer” algorithm. This algorithm may be an initial vision transformer-based DVPS algorithm, which may have a basic structure that uses a multi-branch network structure for multitasking and may include two branches-a panoptic branch that processes a panoptic segmentation task and a depth branch that processes a depth estimation task. The algorithm may use several types of object representation, including multiple representations (e.g., queries) such as stuff/thing/depth, to represent visual information or depth information of objects of different classes. Based on such representations and image features, using the PolyphonicFormer algorithm may obtain an instance-level depth prediction result and mask prediction result.

As non-limiting examples, information of an image may include depth-related and/or visual-related information for an image (e.g., depth and/or depth perception information and/or different visual information of an image or object(s) in the image). Such image information of the image may additionally or alternatively include information derived from the non-limiting example depth-related information and/or information derived from the non-limiting example visual-related information.

The PolyphonicFormer algorithm may use the multi-branch network structure, which may typically be relatively complex and may not be conducive to future distribution optimization. In addition, for networks with different branches, competition between tasks may be intensified, and the PolyphonicFormer algorithm may not be conducive to convergence for an optimal solution.

In addition, the PolyphonicFormer algorithm may typically use multiple object representations to individually represent different properties (thing/stuff/depth) of objects. Such a biased representation method may not fully use the complementarity between different information and may tend to converge in a suboptimal solution and thus have a degraded prediction accuracy.

In a non-limiting example, a method may represent entire information (including two-dimensional (2D) visual information and three-dimensional (3D) depth information) of a panoptic object in a video using a depth-aware object representation (also referred to herein as a “depth-aware representation”) in order to fully use a relationship between depth information and segmentation information.

In an example, a depth-aware feature generation model may be used to fuse and generate a depth-aware feature, and a depth-aware decoder may be used to refine a depth-aware representation and a depth-aware feature step-by-step to ultimately predict category, mask, and depth information of a panoptic object in a video. In an example, visual information and depth information of a video may be employed to improve the algorithm accuracy, and simultaneously a fully integrated pipeline (i.e., a single branch) for an end-to-end DVPS task may be used to remove the need to use multiple individual representations of different object properties or multiple branches for performing a specific task, and, in a non-limiting example, this simplified structure may be more conducive to the algorithm distribution.

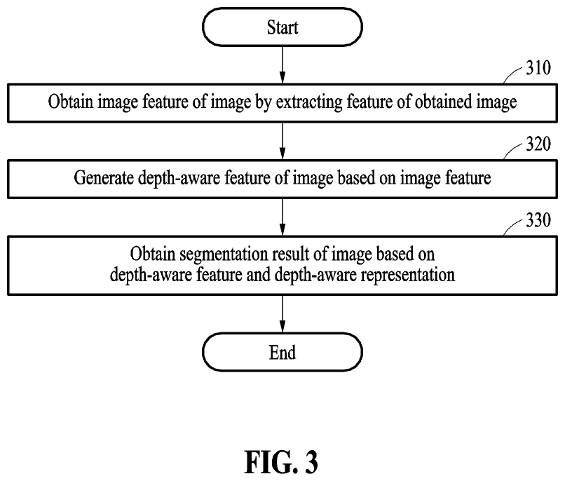

FIG. 3 illustrates an example image processing method according to one or more embodiments.

Referring to FIG. 3, in a non-limiting example, in operation 310, the image processing method may obtain an image feature of an obtained image by performing feature extraction on the image.

The obtained image may be, for example, a single image or a specific frame image of a video.

In an example, the image processing method may extract features of the image using a neural network-based feature extraction model and obtain an image feature of the image. In a non-limiting example, the feature extraction model may include a backbone network (e.g., resnet50 and Swin transformer) and a neck network (e.g., a feature pyramid network (FPN)), and the extracted image feature may include feature maps of different scales which may be referred to as a “multi-scale feature.” The feature extraction method described above is provided only as an example, and examples are not limited thereto.

In operation 320, the image processing method may generate a depth-aware feature of the image based on the image feature. The depth-aware feature may be construed as including a depth information-related feature and a visual information-related feature.

In an example, the image processing method may generate the depth-aware feature of the image using a neural network-based depth-aware feature generation model. Based on the image feature, it may obtain a depth feature and a visual feature (also referred to as a semantic feature) of the image, and may obtain the depth-aware feature by fusing the depth feature and the visual feature. Such a feature fusion described herein may include at least one of, for example, feature addition, feature multiplication, feature concatenation, and the like.

In an example, the depth-aware feature generation model may perform depth feature extraction on the image feature to obtain the depth feature of the image, perform visual feature extraction on the image feature to obtain the visual feature of the image or directly use the image feature as the visual feature, and obtain the depth-aware feature by fusing the depth feature and the visual feature. In an example, under the assumption that the size of the extracted image feature is C×H×W, the image processing method may output a depth-aware feature of the size of C×H×W through the depth-aware feature generation model. In this example, C may denote the number of channels of a feature map and a depth-aware representation, and H and W may denote a resolution (H is height and W is width) of the image. Specifically, the depth-aware feature generation model may perform a convolution operation on the image feature to obtain the depth feature and perform another convolution operation on the image feature to obtain the visual feature.

In an example, the size of the depth feature may be D×H×W, and the size of the visual feature may be C×H×W. The depth feature used herein may be represented based on the number D of depth value discretization intervals (or bins). For example, under the assumption that a depth value to be estimated is a value from zero (0) to 80 meters, a depth value range may be converted into 80 discrete intervals (D=80) with an interval length of 1 meter, for example, 0 to 1, 1 to 2, 2 to 3, . . . , and 79 to 80, respectively. In this way, successive depth estimation may determine a probability that an estimated depth belongs to each interval (or bin), assign a weight to a median value of intervals, calculate an average, and obtain successive estimated depth values. To define the intervals, a uniform division method may be used, or other interval division methods may also be employed.

In an example, the depth-aware feature generation model may obtain a first visual feature and a first depth feature by performing a convolution operation on the visual feature and the depth feature, respectively. The depth-aware feature generation model may then obtain a first feature by fusing the first visual feature and the first depth feature. The depth-aware feature generation model may then obtain a second feature by fusing the first feature and the first depth feature. The depth-aware feature generation model may then obtain the depth-aware feature based on sequential feature concatenation and feature transformation of the second feature and the visual feature. In example, in the case of the visual feature, the depth-aware feature generation model may go through a plurality of convolutional layers (e.g., two to three convolutional layers) to obtain the first visual feature of the size of C×H×W, and in the case of the depth feature, may go through a plurality of convolutional layers (e.g., two to three convolutional layers) and perform a convolution operation to obtain the first depth feature of the size of D×H×W. The depth-aware feature generation model may perform a matrix multiplication on the first visual feature and the first depth feature to obtain the first feature of the size of D×C, and perform a matrix multiplication on the first feature and the first depth feature to obtain the second feature of the size of C×H×W. The depth-aware feature generation model may concatenate the second feature and the visual feature to obtain a feature of the size of 2C×H×W, and may allow this feature to go through a plurality of convolutional layers (e.g., two to three layers) to obtain the depth-aware feature of the size of C×H×W. The depth-aware feature obtained by the depth-aware feature generation model may be construed as an interval-level (or bin-level herein) depth-aware feature. The term “feature concatenation” used herein may refer to sequentially concatenating two features (e.g., two feature matrices) or concatenating two features in a predetermined order or according to a predetermined rule. The term “feature transformation” used herein may refer to transforming the dimension, shape, or size of a feature (e.g., a feature vector/matrix) into a specified dimension or shape.

In an example, the image processing method may use, as part of the depth-aware feature, a feature (i.e., a bin-level depth-aware feature referred to as a “third feature” herein) obtained by sequentially performing feature concatenation and feature transformation on the second feature and the visual feature, and may obtain a fourth feature by reshaping the dimension/size of the depth feature. The image processing method may, in a non-limiting example, obtain a first depth-aware feature by fusing the fourth feature and a depth-related depth position embedding, and may obtain a final depth-aware feature by fusing the third feature and a first depth position feature.

In an example, the image processing method may perform a softmax operation on the depth feature of the size of D×H×W to obtain a feature of the size of D×H×W, and perform a weighted average on the feature to reshape it into the fourth feature of the size of (dmax−dmin+1)×H×W. In this case, dmax and dmin may denote a meter-level maximum depth value and a meter-level minimum depth value, respectively. For example, in the application of autonomous driving, the maximum depth value may be generally 80 meters, and the minimum depth value may be generally 0 meters. The image processing method may perform a matrix multiplication on the fourth feature and the depth-related position embedding (a corresponding algorithm may be a standard algorithm, and the size of its result may be (dmax−dmin+1)×C) to obtain a depth position feature (also referred to as a depth position map) of the size of C×H×W. The image processing method may then obtain the final depth-aware feature by adding the depth position feature to the third feature.

In operation 330, in a non-limiting example, the image processing method may obtain a segmentation result of the image based on the depth-aware feature and a depth-aware representation.

In a non-limiting example, depth-aware representation (or a depth-aware query) may include depth information and visual information for predicting a segmentation result of an image or a video. The depth-aware representation may be used to encode all information about a panoptic object, including both the depth information and the visual information. Specifically, a single panoptic object may be represented by one vector (vector length C), and under the assumption that there are maximally L panoptic objects in a single image (where L is a maximum value of a vector that is generally set to be greater than the number of panoptic objects in a frame), all the panoptic objects in the single image may be represented by an L×C matrix, i.e., a depth-aware object-centric representation. The depth-aware representation may be a matrix, and a vector of the matrix may represent an object in the image.

In an example, a vector of a depth-aware representation matrix may be used to represent an object in an image, each vector may correspond to one object, and each vector may include some parameters used to predict a mask, a category, a depth, and an instance of a corresponding object. In addition, a depth-aware representation used in an initial step may be a preset initial matrix, and the same initial matrix may be used to process another frame.

The depth-aware representation, which may be part of the algorithm parameters described herein, may be continuously optimized and determined during a training process. During an inference process, the depth-aware representation may be fixed for different video frames in an initial step (i.e., the same initial depth-aware representation may be used for individual frames of a video), the initial depth-aware representation may be refined accordingly for each subsequent video frame, and a refined depth-aware representation may then be obtained for each video frame.

In an example, the image processing method may refine the depth-aware representation to obtain a refined depth-aware representation, and may obtain a depth prediction result of the segmentation result based on the refined depth-aware representation and the depth-aware feature. The image processing method may enhance the depth-aware feature to obtain an enhanced depth-aware feature, and may obtain a mask prediction result and a category prediction result of the segmentation result based on the refined depth-aware representation and the enhanced depth-aware feature (or an unenhanced depth-aware feature may also be used). In an example, a depth-aware decoder may perform a relational operation between the depth-aware representation and the depth-aware feature based on a generated depth-aware feature and a depth-aware representation obtained through training, and may continuously obtain a refined depth-aware representation and an enhanced depth-aware feature through a plurality of steps. In addition, the depth-aware decoder may predict mask, category, and depth estimation results of a panoptic object of an image, using the refined depth-aware representation and the enhanced depth-aware feature.

When refining the depth-aware representation, the image processing method may process the depth-aware representation through a first attention network (e.g., a self-attention network) to obtain the first depth-aware representation, and may fuse the depth-aware representation and the first depth-aware representation and normalize a feature-fused representation obtained by the fusing to obtain the second depth-aware representation. The image processing method may process the depth-aware feature and the second depth-aware representation through a second attention network (e.g., a mutual attention network) to obtain a third depth-aware representation, and may fuse the second depth-aware representation and the third depth-aware representation and normalize a feature-fused representation obtained by the fusing to obtain a fourth depth-aware representation. The image processing method may then obtain a refined depth-aware representation based on the fourth depth-aware representation using a feedforward network.

In an example, in the case of an input depth-aware representation, the image processing method may obtain a first depth-aware representation of the size of L×C by transmitting information between different panoptic objects using a self-attention network. The attention network may have three inputs-Q, K, and V. In this case, the inputs Q, K, and V of the self-attention network may be set as the input depth-aware representation. The image processing method may perform addition (e.g., feature addition) and normalization on the first depth-aware representation and the input depth-aware representation to obtain a second depth-aware representation of the size of L×C. The image processing method may obtain a third depth-aware representation of the size of L×C by transmitting information between an object representation and a feature using a mutual attention network for the second depth-aware representation and an input depth-aware feature. In this case, the input Q of the mutual attention network may be set as the second depth-aware representation, and both K and V may be set as the depth-aware feature. The image processing method may perform addition and normalization on the second depth-aware representation and the third depth-aware representation to obtain a fourth depth-aware representation of the size of L×C. The image processing method may allow the fourth depth-aware representation to pass through a feedforward neural network (FFN) to obtain a refined depth-aware representation.

In an example, the image processing method may perform a linearization operation on the refined depth-aware representation to obtain a fifth feature, perform a convolution operation on the depth-aware feature to obtain a sixth feature, and fuse the fifth feature and the sixth feature to obtain a seventh feature. The image processing method may fuse the seventh feature and the fifth feature to obtain an eighth feature, and fuse the eighth feature and the sixth feature to obtain a ninth feature. The image processing method may then obtain a depth prediction result based on the ninth feature using a depth prediction network (also referred to as a depth estimator). For example, the image processing method may obtain the fifth feature of the size of L×D through a plurality of linear layers for the refined depth-aware representation, and obtain the sixth feature of the size of D×H×W through a plurality of convolutional layers for the depth-aware feature. The image processing method may perform a matrix multiplication on the fifth feature and the sixth feature to obtain the seventh feature of the size of L×H×W, perform a matrix multiplication on the fifth feature and the seventh feature to obtain the eighth feature of the size of D×H×W, and perform element-wise addition on the eighth feature and the sixth feature to obtain the ninth feature of the size of D×H×W. The image processing method may obtain the depth prediction result by inputting the ninth feature to a depth estimation network.

In an example, the depth estimation network may perform a pooling operation and a linear operation on the ninth feature to obtain a feature weight corresponding to the ninth feature, and perform a linear operation on the ninth feature and the feature weight to obtain the depth prediction result. For example, the depth estimation network may perform the pooling operation on the ninth feature to obtain a result of the size of D×1 (i.e., practically, a D-dimensional vector), and perform the linear operation (e.g., through one or more linear layers) on the result to obtain a vector of the size of D×1. The image processing method may use the obtained D-dimensional vector as a weight, and perform a linear combination (i.e., a dot product calculation on two D-dimensional vectors for each pixel) on the ninth feature (e.g., the size of D×H×W with one D-dimensional vector for each pixel) to obtain a result of the size of H×W, i.e., the depth prediction result.

In an example, the image processing method may perform a convolution operation on the depth-aware feature of the enhanced depth-aware feature to obtain a tenth feature, and perform a convolution operation on enhanced depth information to obtain an 11th feature. The enhanced depth information may be obtained in a process of predicting the depth prediction result. The image processing method may fuse the tenth feature and the 11th feature to obtain a 12th feature, and fuse the 11th feature and the 12th feature to obtain a 13th feature. The image processing method may then sequentially perform feature concatenation and feature transformation on the 13th feature and the depth-aware feature to obtain the enhanced depth-aware feature. For example, in the case of the depth-aware feature, the image processing method may obtain the tenth feature of the size of C×H×W through a plurality of convolutional layers, and in the case of the enhanced depth information, may obtain the 11th feature of the size of D×H×W through a plurality of convolutional layers. The image processing method may perform a matrix multiplication on the tenth feature and the 11th feature to obtain the 12th feature of the size of D×C, and perform a matrix multiplication on the 11th feature and the 12th feature to obtain the 13th feature of the size of C×H×W. The image processing method may concatenate the 13th feature and the input depth-aware feature to obtain a feature of the size of 2C×H×W, and may allow this feature to pass through a plurality of convolutional layers to obtain the enhanced depth-aware feature of the size of C×H×W.

In an example, the image processing method may sequentially perform feature concatenation and feature transformation on the 13th feature and the depth-aware feature to obtain a 14th feature (as part of a final enhanced depth-aware feature), and reshape the dimension of the enhanced depth information to obtain a 15th feature. The image processing method may perform a multiplication on the 15th feature and a depth-related position embedding to obtain a second depth position feature (as another part of the final enhanced depth-aware feature), and fuse the 14th feature and the second depth position feature to obtain the final enhanced depth-aware feature.

After obtaining the refined depth-aware representation and the enhanced depth-aware feature, the image processing method may obtain the category prediction result based on the refined depth-aware representation using a first linear layer. The image processing method may obtain a 16th feature based on the refined depth-aware representation using a second linear layer, and fuse the 16th feature and the enhanced depth-aware feature to obtain the mask prediction result. In this case, the image processing method may also use unenhanced depth-aware feature, i.e., an input depth-aware feature, in a process of calculating the mask prediction result.

In an example, in the case of the refined depth-aware representation, the image processing method may directly obtain the category prediction result through a plurality of linear layers, and in the case of the refined depth-aware representation, may obtain the 16th feature of the size of L×C through a plurality of additional linear layers. The image processing method may perform a matrix multiplication on the 16th feature and the enhanced depth-aware feature to obtain the mask prediction result. Alternatively, the image processing method may obtain the mask prediction result by performing a matrix multiplication on the 16th feature and the input depth-aware feature.

In an example, for video segmentation, image segmentation may be performed in a frame unit in the manner as described above. For example, for two frame images, the image processing method may obtain a refined depth-aware representation of a current frame image and a refined depth-aware representation of a previous frame image of the current frame image, and may perform similarity matching between the refined depth-aware representation of the current frame image and the refined depth-aware representation of the previous frame image such that the same instance of the current frame image and the previous frame image have a unified indicator. In the case of refined depth-aware representations obtained from different frames, the image processing method may use a tracking head (e.g., a neural network) to establish a corresponding relationship between instances of the frames to obtain an integrated instance identifier (ID).

As non-limiting examples, an example machine learning model (e.g., a deep learning or other machine learning network) may have several portions for one or more operations and/or tasks. As respective non-limiting examples, a backbone of a larger model may include one or more feature extraction and/or other feature-determining operations, a neck of a larger model may extract and/or determine more elaborate and/or more abstracted information and/or features (e.g., dependent on features extracted by the backbone), and a head of the larger model may perform one or more tasks to obtain respective results or outputs (e.g., dependent on the operations of the neck, or dependent on respective operations of the neck and backbone). While the respective example operations/tasks of the backbone, neck, and head of a larger model have been mentioned here, examples are not limited to the same, as such different portions may perform other operations and/or tasks, may be provided in alternate locations of the larger model, may be performed in series and/or in parallel with each other, and the larger model may include any one or any combination of one or more backbones, one or more necks, one or more heads, or one or more additional and/or alternate portions.

Optionally, the image processing method may process the refined depth-aware representation of the current frame image and the refined depth-aware representation of the previous frame image by a third attention network, and may obtain a refined depth-aware representation of a time-domain context and determine it to be the refined depth-aware representation. In the case of refined depth-aware representations obtained from different frames, the image processing method may obtain a refined depth-aware representation of a time-domain context, using the third attention network. For example, the image processing method may output the refined depth-aware representation including the time-domain context, using a time-domain slot attention network (i.e., a neural network).

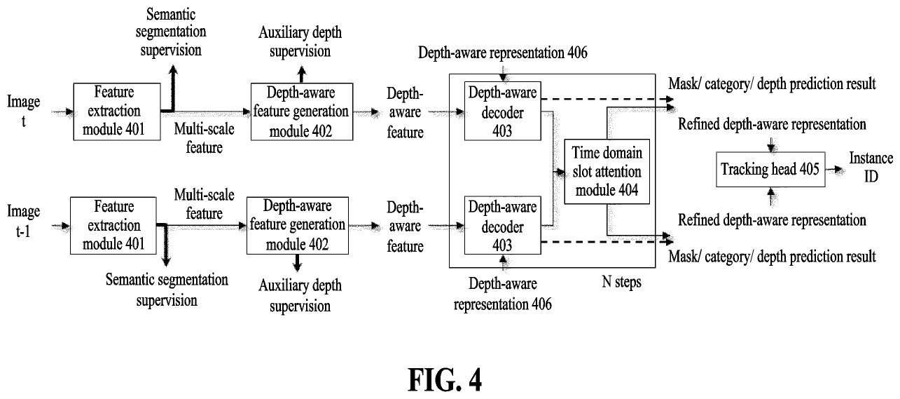

FIG. 4 illustrates an example DVPS algorithm according to one or more embodiments.

In an example, an algorithm as described above may be implemented as a neural network, and the neural network may apply a depth-aware representation 406 as a network parameter to encode all information of a panoptic object. A depth-aware representation (or a depth-aware query) used herein may include visual information and depth information. Specifically, one panoptic object may be represented by one vector (vector length C), and under the assumption that there are maximally L panoptic objects in one image, all the panoptic objects in the image may be represented by an L×C matrix, i.e., a depth-aware object-centric representation. The depth-aware representation 406, which may be part of the algorithm parameters, may be continuously optimized and determined during supervised learning (or training) and may be fixed for different video frames during an inference process (i.e., the same initial depth-aware representation may be used for individual frames of a video). Two main models of the algorithm process may be a depth-aware feature generation model 402 and a depth-aware decoder 403. The depth-aware feature generation model 402 may obtain a depth-aware feature by fusing a depth-related feature and a visual-related feature at a feature level, and the depth-aware decoder 403 may perform a relational operation between a depth-aware representation and a depth-aware feature and a relational operation between depth-aware representations of different frames (i.e., the relational operation between depth-aware representations of different frames may be optionally performed by a time-domain slot attention model 404), continuously refine the depth-aware representation and an enhanced depth-aware feature to ultimately obtain mask, category, and depth estimation results of a panoptic object in an image. The refined depth-aware representations between the frames may be used to obtain a unified instance ID (i.e., the same instance is recognized in different frames) through similarity matching (performed by a tracking header 405).

Referring to FIG. 4, in a non-limiting example, a general feature extraction model 401 may be used to extract an image feature from a frame t of a video.

A general feature extraction method may include, for example, a method using a backbone network (e.g., resnet50 and Swin transformer) and a method using a neck network (e.g., FPN), and an extracted feature may include feature maps of various scales and may thus be referred to as a “multi-scale feature.”

The extracted image feature may be supervised using a semantic segmentation label. In this case, a supervision process may be used only in a training (or learning) step but not in an inference step.

For the extracted multi-scale feature, the depth-aware feature generation model 402 may be used to obtain a depth-aware feature (including a multi-scale one). The depth-aware feature generation model 402 may internally use a real depth value label to extract a depth information-related feature on which supervision (auxiliary depth supervision) is performed. The supervision process may be used only in the training (or learning) step but not in the inference step.

For the extracted depth-aware feature and the learned depth-aware representation 406, the image processing method may use the depth-aware decoder 403 to perform a relational operation between the depth-aware representation and the depth-aware feature, continuously obtain a refined depth-aware representation and an enhanced depth-aware feature through multiple steps (e.g., N steps), and predict mask, category, and depth estimation results of a panoptic object in the frame t.

In an example, for an adjacent frame (e.g., a frame t−1) of the frame t, the image processing method may extract an image feature using the general feature extraction model 401, obtain a depth-aware feature using the depth-aware feature generation model 402, obtain a continuously refined depth-aware representation and an enhanced depth-aware feature through multiple steps (e.g., N steps) using the depth-aware decoder 403, and based on this, obtain mask, category, and depth estimation results of a panoptic object in the frame t−1. In this case, the same depth-aware representation 406 may be used for the frame t−1 and the frame t.

For refined depth-aware representations obtained from different frames, the time-domain slot attention model 404 may be used to output a refined depth-aware representation including a time-domain context, i.e., a further refined depth-aware representation. The time-domain slot attention model 404 may be optional and may not be used.

For the refined depth-aware representations obtained from the different frames (or refined depth-aware representations including the time-domain context), the image processing method may use the tracking header 405 to establish a corresponding relationship between instances of the frames and obtain an integrated instance ID. The models (e.g., depth-aware feature generation model 402, etc.) may be implemented by neural networks.

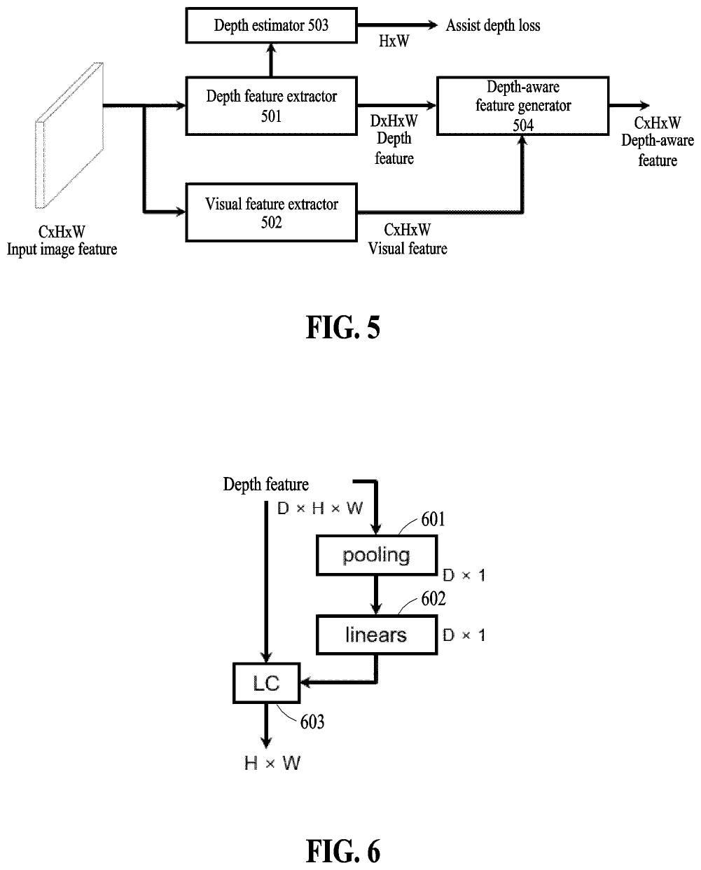

FIG. 5 illustrates an example depth-aware feature generation model according to one or more embodiments.

Referring to FIG. 5, in a non-limiting example, FIG. 5 illustrates the depth-aware feature generation model 402 of FIG. 4, and an input image feature may be an image feature (the size of a feature map is represented as C×H×W) extracted by the feature extraction model 401, and an output may be a depth-aware feature (the size of a feature map is maintained as C×H×W). Referring to FIG. 5 and following diagrams, some constants may be used to represent the dimensions of a vector and a tensor. For example, L may denote a maximum number (assumed to be 100) of panoptic objects in a single image, C may denote a channel dimension of a feature map and a depth-aware representation, H and W may correspond to a resolution (H is the height, and W is the width) of the image, and D may denote the number of intervals in which depth values are discretized. Under the assumption that a depth value to be estimated is between 0 and 80 meters, a depth value range may be converted into 80 intervals with an interval length of 1 meter, for example, 0 to 1, 1 to 2, 2 to 3, . . . , and 79 to 80. In this way, such successive depth estimation may determine a probability that an estimated depth belongs to each interval, assign a weight to a median value of intervals, calculate an average, and obtain successive estimated depth values. To define the intervals, the simplest uniform division method may be used, but in the actual algorithm, D may be selected as 64, non-uniform interval division may be used, and specific interval division may be obtained through network estimation according to input data.

In an example, a depth feature extractor 501 may obtain a depth feature by performing a convolution operation based on the input image feature. The structure of this model may be an extremely light network structure that includes a plurality of convolutional layers, for example.

In an example, a visual feature extractor 502 may obtain a visual feature by performing a convolution operation based on the input image feature. The structure of the visual feature extractor 502 may be an extremely light network structure that includes only a plurality of convolutional layers. The visual feature extractor 502 may be optional and may directly use the input image feature as a visual feature.

In an example, a depth estimator 503 may estimate a depth value for each pixel based on the depth feature. The depth estimator 503 may be used to train a model that assists with depth loss. In this case, a scale-invariant loss used in BinsForme may be used.

In an example, a depth-aware feature model 504 may obtain a depth-aware feature by fusing the visual feature and the depth feature.

FIG. 6 illustrates an example depth estimator according to one or more embodiments. Referring to FIG. 6, in a non-limiting example, a structure of the depth estimator 503 of FIG. 5 is illustrated. An input of the depth estimator 503 may be a depth feature (i.e., an output of the depth feature extractor 501 with the size of D×H×W), and an output thereof may be an estimated depth value (with the size of H×W) for each pixel. The input and the output of this model may be tensors, and the dimensions of the tensors may be as shown in FIG. 6.

In an example, the depth estimator 503 may perform a pooling operation 601 on the depth feature to obtain a result of the size of D×1 (actually, one D-dimensional vector). For example, it may perform a max pooling operation or an average pooling operation on the depth feature. The depth estimator 503 may perform a linear operation 602 (which may include one or more linear layers (i.e., “linears”) on the result of the pooling operation to obtain a result whose size is still maintained as D×1. The depth estimator 503 may perform a linear combination (i.e., “LC”) 603 (e.g., a dot product operation of two D-dimensional vectors for each pixel) on the depth feature (of the size of D×H×W, i.e., a one D-dimensional vector for each pixel) using the D-dimensional vector obtained in the linear operation 602 as a weight to obtain a result of the size of H×W. This result may be a predicted depth value, and supervision may be performed using an actual depth value in a training (or learning) step. For assisting with a depth loss, a scale-invariant loss used in BinsFormer may be used.

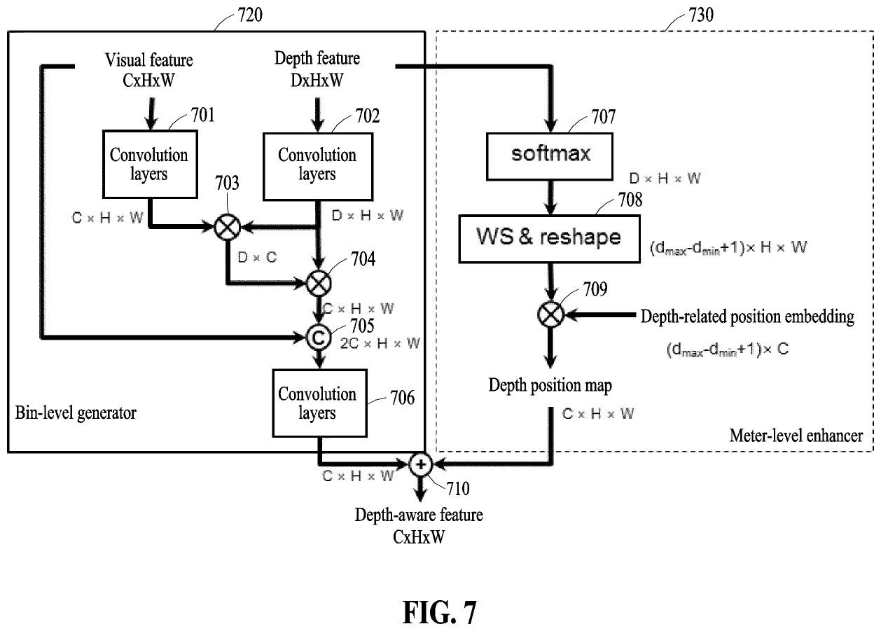

FIG. 7 illustrates an example depth-aware feature model according to one or more embodiments.

Referring to FIG. 7, in a non-limiting example, a structure of the depth-aware feature model 504 of FIG. 5 is illustrated. An input of the depth-aware feature model 504 may be a visual feature (obtained by the visual feature extractor 502) and a depth feature (obtained by the depth feature extractor 501), and an output thereof may be a depth-aware feature. The depth-aware feature model 504 may use pixel-level depth information to enhance the visual feature at both a bin level and a meter level. A left side of FIG. 7 may correspond to a bin-level model 720 (corresponding to steps 701 to 706 described below), and a right side thereof may correspond to a meter-level model 730 (corresponding to steps 707 to 709 described below), and these two may be combined at Step 710 and a final depth-aware feature may be obtained. In an example, an adaptive dynamic interval definition used on the left side may be used to learn global depth distribution information, and a fixed meter-level interval used on the right side may be used to learn detailed depth information. These two parts may be complementary to some extent and may thus enhance the model performance. In this case, the meter-level model 730 on the right side may be an optional model, and only the bin-level model 720 on the left side may only be used. The input and the output of the depth-aware feature model 504 may be tensors, and the dimensions of the tensors may be as shown in FIG. 7.

In an example, in step 701, for the input visual feature, the depth-aware feature model 504 may convert the input visual feature through a plurality of convolutional layers (e.g., two to three layers) to obtain a feature whose size is maintained as C×H×W.

In an example, in step 702, for the input depth feature, the depth-aware feature model 504 may convert the input depth feature through a plurality of convolutional layers (e.g., two to three layers) to obtain a feature whose size is maintained as D×H×W.

In an example, in step 703, the depth-aware feature model 504 may perform a matrix multiplication on results from steps 701 and 702 to obtain a feature of the size of D×C. In this case, ⊗ may denote the matrix multiplication.

In an example, in step 704, the depth-aware feature model 504 may perform a matrix multiplication on results from steps 703 and 702 to obtain a feature of the size of C×H×W.

In an example, in step 705, the depth-aware feature model 504 may concatenate a result of step 704 and an input representation feature to obtain a feature of the size of 2C×H×W. In this case, \textcircled{c} may denote the feature concatenation.

In an example, in step 706, the depth-aware feature model 504 may apply a plurality of convolutional layers (e.g., 2 to 3 layers) to the feature obtained in step 705 to obtain a feature of the size of C×H×W.

In an example, in step 707, for the input depth feature, the depth-aware feature model 504 may perform a softmax operation to obtain a feature of the size of D×H×W.

In an example, in step 708, the depth-aware feature model 504 may perform a weighted average (or WS as indicated) of the feature obtained in step 707 to reshape it into a feature of the size of (dmax−dmin+1)×H×W. In this case, dmax and dmin may be a meter-level maximum depth value and a meter-level minimum depth value, respectively. The maximum depth value and the minimum depth value may be set according to an application scenario, for example, they may be generally set to 80 meters and 0 meters, respectively, in the application of autonomous driving.

In an example, in step 709, the depth-aware feature model 504 may perform a matrix multiplication on the feature obtained in step 708 and a depth position embedding (a corresponding algorithm is a standard algorithm and the size of its result is (dmax-dmin+1)×C) to obtain a depth position map of the size of C×H×W.

In an example, in step 710, the depth-aware feature model 504 may add the features obtained in steps 706 and 709 respectively into a depth-aware feature of a final output. In this case, β may denote an element-wise addition.

According to the process described above with reference to FIG. 7, a depth-aware feature Xₜ^{m} may be calculated as expressed in Equation 1 below.

$${X}_{t}^{m} = CA ( {X}_{t}^{s} , {X}_{t}^{d} , {X}_{t}^{d} ) + {X}_{t}^{e} \cdot {P}^{m} \qquad Equation 1$$

In Equation 1, Xₜ^{s} may denote a visual feature of an input, XC may denote a depth feature of the input, Xₜ^{e} may denote a mapped depth feature (i.e. an output result from step 708), p^{m} may denote a depth position embedding, and CA( ) may denote a mutual attention function.

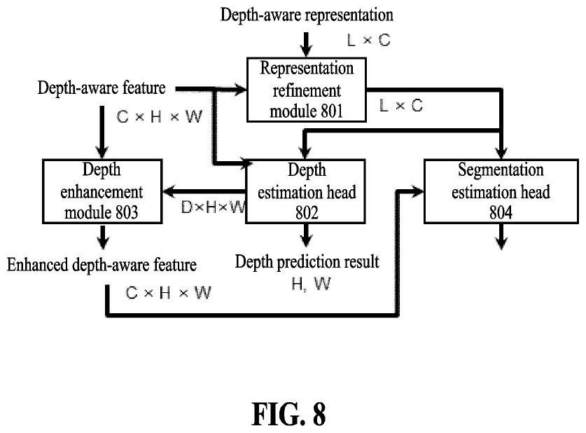

FIG. 8 illustrates an example depth-aware decoder according to one or more example embodiments.

Referring to FIG. 8, in a non-limiting example, a structure of the depth-aware decoder 403 of FIG. 4 is illustrated. An input to the depth-aware decoder 403 may be a depth-aware representation and a depth-aware feature, and an output thereof may be a refined depth-aware representation (e.g., an output of a representation refinement model 801), an enhanced depth-aware feature (e.g., an output of a depth enhancement model 803), a depth prediction result (e.g., an output of a depth estimation head 802), and mask and category prediction results (e.g., an output of a segmentation estimation head 804). The depth-aware decoder 403 may be called in N steps (where N is 4 to 7, refer to the “N steps” of FIG. 4), and an input of a subsequent step (including the depth-aware representation and the depth-aware feature) may be an output of a previous step (including the refined depth-aware representation and the enhanced depth-aware feature). The input and the output of the depth-aware decoder 403 may be tensors, and the dimensions of the tensors may be as shown in FIG. 8.

In an example, the depth-aware decoder 403 may perform depth-aware representation-based refinement on the input depth-aware representation and the input depth-aware feature through the representation refinement model 801 to obtain a refined depth-aware representation.

In an example, the depth-aware decoder 403 may obtain enhanced depth information (of the size of D×H×W, as an input of the depth enhancement model 803) and a depth prediction result, through the depth estimation head 802, for the refined depth-aware representation and the depth-aware feature.

In an example, the depth-aware decoder 403 may obtain an enhanced depth-aware feature through the depth enhancement model 803 for the input depth-aware feature and the enhanced depth information obtained by the depth estimation head 802.

In an example, the depth-aware decoder 403 may obtain a mask prediction result and a category prediction result through the segmentation estimation head 804, for the refined depth-aware representation (e.g., the output of 801) and the enhanced depth-aware feature (e.g., the output of 803). In this case, nc may denote a total number of categories.

In this case, the input to the segmentation estimate head 804 may be the enhanced depth-aware feature or may be replaced using the input depth-aware feature (i.e., the input to 403).

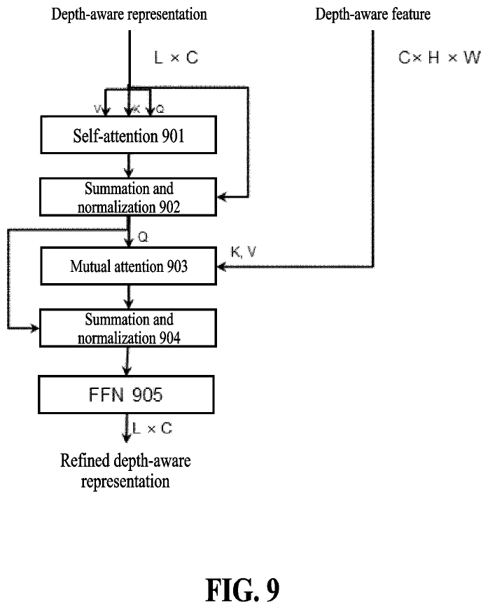

FIG. 9 illustrates an example refinement model according to one or more embodiments.

Referring to FIG. 9, a structure of the representation refinement model 801 of FIG. 8 is illustrated. An input to the representation refinement model 801 may be a depth-aware representation and a depth-aware feature, and an output thereof may be a refined depth-aware representation (e.g., an output of 905). The input and the output of the representation refinement model 801 may be tensors, and the dimensions of the tensors may be as illustrated in FIG. 9.

In an example, for the input depth-aware representation, the representation refinement model 801 may transmit information between different panoptic objects using a general self-attention model 901 to obtain a result of the size of L×C. In this case, inputs Q, K, and V of the self-attention model 901 may correspond to the depth-aware representation.

In an example, a model 902 may add the result of the self-attention model 901 and the input depth-aware representation and normalize it to obtain a feature of the size of L×C.

For the output of 902 and the input depth-aware feature, the representation refinement model 801 may transmit information between an object representation and a feature using a general mutual attention model 903 to obtain a feature of the size of L×C. In this case, the input Q of the mutual attention model 903 may use the output of 902, and both K and V may use the depth-aware feature.

In an example, a model 904 may add the result of the mutual attention model 903 and the output of 902 and normalize it to obtain a feature of the size of L×C.

In an example, a model 905 may obtain a refined depth-aware representation through an FFN operation on the result of 904.

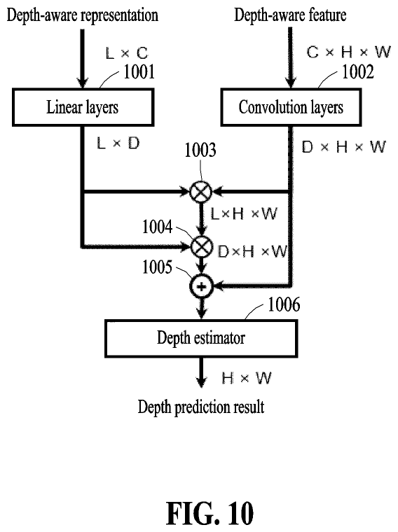

FIG. 10 illustrates an example depth estimation head according to one or more embodiments.

Referring to FIG. 10, in a non-limiting example, a structure of the depth estimation head 802 of FIG. 8 is illustrated. An input to the depth estimation head 802 may be a depth-aware representation and a depth-aware feature, and an output thereof may be a depth prediction result. The input and the output of the depth estimation head 802 may be tensors, and the dimensions of the tensors may be as illustrated in FIG. 10. The depth estimation head 802 may be implemented by a neural network.

In an example, in step 1001, for the depth-aware representation, the depth estimation head 802 may obtain a feature of the size of L×D through a plurality of linear layers.

In an example, in step 1002, for the depth-aware feature, the depth estimation head 802 may obtain a feature of the size of D×H×W through a plurality of convolutional layers.

In an example, in step 1003, the depth estimation head 802 may perform a matrix multiplication on results of steps 1001 and 1002 to obtain a feature of the size of L×H×W.

In an example, in step 1004, the depth estimation head 802 may perform a matrix multiplication on results of steps 1001 and 1003 to obtain a feature of the size of D×H×W.

In an example, in step 1005, the depth estimation head 802 may perform element-wise addition on results of steps 1004 and 1002 to obtain a feature of the size of D×H×W.

In an example, in step 1006, the depth estimation head 802 may input a result of step 1005 to a depth estimator (e.g., the depth estimator of FIG. 6) to obtain a depth prediction result.

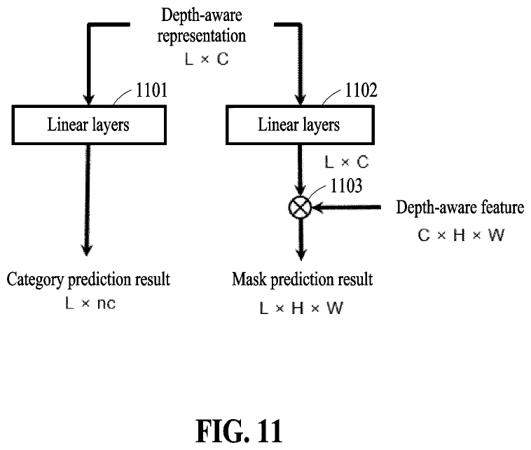

FIG. 11 illustrates an example segmentation estimation head according to one or more embodiments.

Referring to FIG. 11, in a non-limiting example, a structure of the segmentation estimation head 804 of FIG. 8 is illustrated. An input of the segmentation estimation head 804 may be a depth-aware representation and a depth-aware feature, and an output thereof may be a category prediction result and a mask prediction result. The input and the output of the segmentation estimation head 804 may be tensors, and the dimensions of the tensors may be as shown in FIG. 11.

In an example, in step 1101, in response to the depth-aware representation, the segmentation estimation head 804 may directly obtain a category prediction result through a plurality of linear layers.

In an example, in step 1102, in response to the depth-aware representation, the segmentation estimation head 804 may obtain a feature whose size is still L×C through a plurality of linear layers.

In an example, in step 1103, the segmentation estimation head 804 may perform a matrix multiplication on the feature obtained in step 1102 and the input depth-aware feature to obtain a mask prediction result.

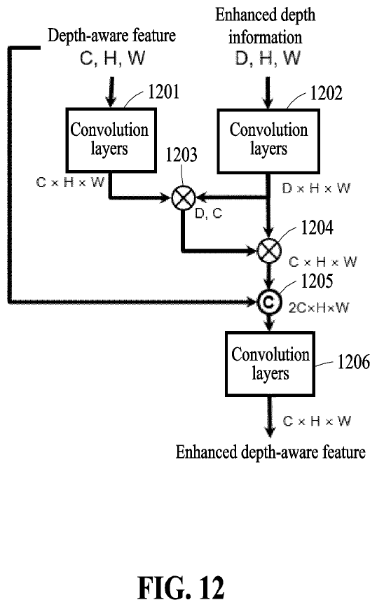

FIG. 12 illustrates an example depth enhancement model according to one or more embodiments.

Referring to FIG. 12, in a non-limiting example, a detailed structure of the depth enhancement model 803 of FIG. 8 is illustrated. An input of the depth enhancement model 803 may be a depth-aware feature (of the dimension of C×H×W) and enhanced depth information (of the dimension of D×H×W), which are fused to obtain an enhanced depth-aware feature. The input and the output of the depth enhancement model 803 may be tensors, and the dimensions of the tensors may be as illustrated in FIG. 12.

In an example, in step 1201, in response to the depth-aware feature, the depth enhancement model 803 may obtain a feature of the size of C×H×W through a plurality of convolutional layers.

In an example, in step 1202, in response to the enhanced depth information, the depth enhancement model 803 may obtain a feature of the size of D×H×W through a plurality of convolutional layers.

In an example, in step 1203, the depth enhancement model 803 may perform a matrix multiplication on results of steps 1201 and 1202 to obtain a feature of the size of D×C.

In an example, in step 1204, the depth enhancement model 803 may perform a matrix multiplication on results of steps 1202 and 1203 to obtain a feature of the size of C×H×W.

In an example, in step 1205, the depth enhancement model 803 may concatenate a result of step 1204 and the input depth-aware feature to obtain a feature of the size of 2C×H×W.

In an example, in step 1206, the depth enhancement model 803 may obtain an enhanced depth-aware feature of the size of C×H×W through a plurality of convolutional layers for the feature obtained in step 1205.

The enhanced depth-aware feature obtained by the process described above with reference to FIG. 12 may be construed as a bin-level enhanced depth-aware feature. In an example, a meter-level enhanced depth-aware feature may also be considered to enhance a depth-aware feature.

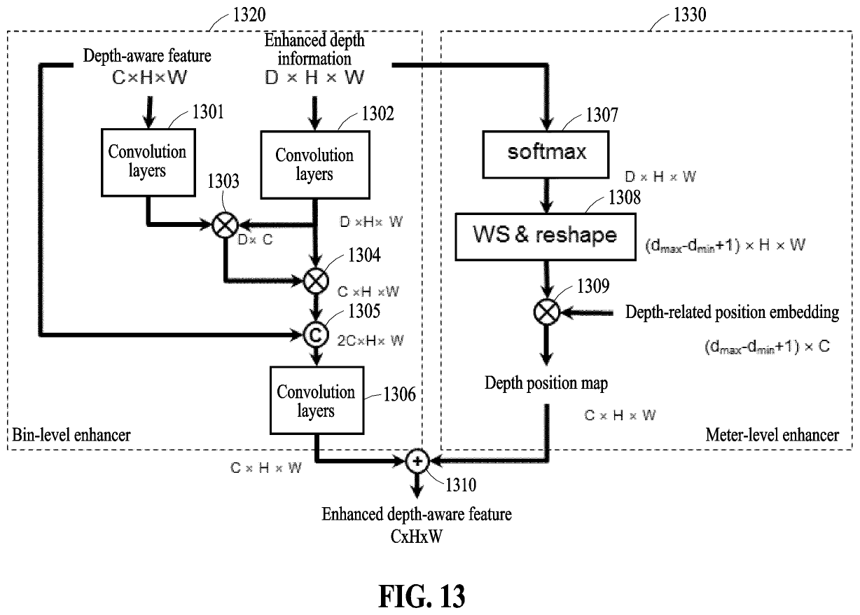

FIG. 13 illustrates an example depth enhancement model according to one or more embodiments.

Referring to FIG. 13, in a non-limiting example, a structure of the depth enhancement model 803 of FIG. 8 is illustrated. An input of the depth enhancement model 803 may be a depth-aware feature (of the dimension of C×H×W) and enhanced depth information (of the dimension of D×H×W), which are fused to obtain an enhanced depth-aware feature. The input and the output of the depth enhancement model 803 may be tensors, and the dimensions of the tensors may be as illustrated in FIG. 13.

In an example, a left side of FIG. 13 may correspond to a bin-level enhancement model 1320 (corresponding to steps 1301 to 1306 described below), and a right side thereof may correspond to a meter-level enhancement model 1330 (corresponding to steps 1307 to 1309 described below), and the two sides may be combined and a final enhanced depth-aware feature may be obtained in Step 1310. The adaptive dynamic interval definition used on the left side may be used to learn global depth distribution information, and a fixed meter-level interval used on the right side may be used to learn detailed depth information. The two parts may be complementary to some extent and may enhance the model performance.

In an example, in step 1301, in response to the depth-aware feature, the depth enhancement model 803 may obtain a feature of the size of C×H×W through a plurality of convolutional layers.

In an example, in step 1302, in response to the enhanced depth information, the depth enhancement model 803 may obtain a feature of the size of D×H×W through a plurality of convolutional layers.

In an example, in step 1303, the depth enhancement model 803 may perform a matrix multiplication on respective results of steps 1301 and 1302 to obtain a feature of the size of D×C.

In an example, in step 1304, the depth enhancement model 803 may perform a matrix multiplication on the features obtained in steps 1302 and 1303, respectively, to obtain a feature of the size of C×H×W.

In an example, in step 1305, the depth enhancement model 803 may concatenate the feature obtained in step 1304 and the input depth-aware feature to obtain a feature of the size of 2C×H×W.

In an example, in step 1306, the depth enhancement model 803 may allow the feature obtained in step 1305 to pass through a plurality of convolutional layers to obtain a bin-level enhanced depth-aware feature of the size of C×H×W.

In an example, in step 1307, the depth enhancement model 803 may perform a softmax operation on the input enhanced depth information to obtain a feature of the size of D×H×W.

In an example, in step 1308, the depth enhancement model 803 may calculate a weighted average of the feature obtained in step 1307 and reshape the feature into a feature of the size of (dmax−dmin+1)×H×W. In this case, dmax and dmin may denote a meter-level maximum depth value and a meter-level minimum depth value, respectively, which may be generally 80 meters and 0 meters in the application of autonomous driving.

In the feature step 1309, the depth enhancement model 803 may perform a matrix multiplication on the feature obtained in step 1308 and a depth-related position embedding (a corresponding algorithm may be a standard algorithm, and the size of its result may be (dmax−dmin+1)×C) to obtain a depth position map of the size of C×H×W.

In the feature step 1310, the depth enhancement model 803 may add the features obtained in steps 1306 and 1309 to obtain a final enhanced depth-aware feature. For example, the depth enhancement model 803 may obtain the final enhanced depth-aware feature through calculation as expressed in Equation 1, as shown above.

In an example, when training a network, the prediction results (i.e., depth, mask, and category prediction results) may need to be restricted to be similar to ground-truth depth, mask, and category, which may be achieved by minimizing a loss function. For example, a corresponding relationship between the predicted mask and the ground-truth mask may be established by a binary matching algorithm. The loss function used may include multiple terms. For example, a segmentation-related loss function may include a pixel-level cross-entropy loss, a panoptic object-level panoptic quality loss, a mask ID loss, and a mask similarity loss (based on a dice coefficient calculation that is generally used). A depth-related loss function may use a scale-invariant loss. The loss function may be provided as an example, but examples are not limited thereto.

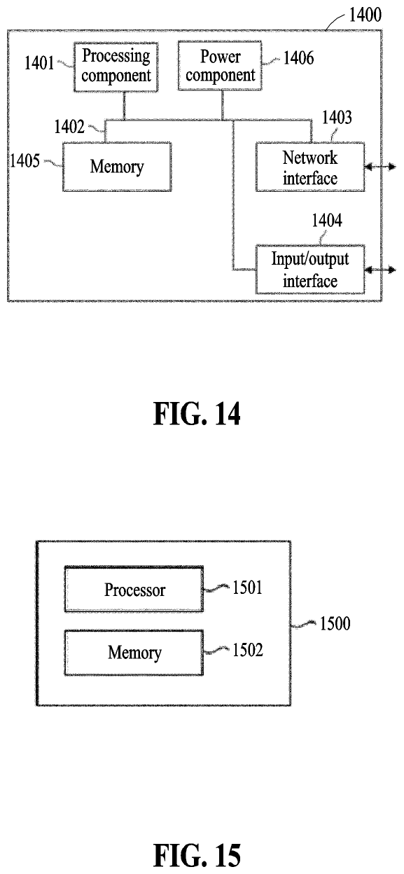

FIG. 14 illustrates an example image processing device in a hardware operating environment according to one or more embodiments.

In an example, an image processing device 1400 may implement an image or video segmentation function as described in greater detail below.

Referring to FIG. 14, in a non-limiting example, the image processing device 1400 may include a processing component 1401, a communication bus 1402, a network interface 1403, an input/output interface 1404, a memory 1405, and a power component 1406. In this case, the communication bus 1402 may be used to implement a connecting communication number between these components. The input/output interface 1404 may include a video display (e.g., a liquid-crystal display (LCD)), a microphone, speakers, a user interaction interface (e.g., a keyboard, a mouse, a touch input device, etc.), and may optionally include a standard wired interface and a wireless interface. The network interface 1403 may optionally include a standard wired interface or a wireless interface (e.g., a wireless fidelity (Wi-Fi) interface). The memory 1405 may be high-speed random-access memory (RAM) or a stable non-volatile memory. The memory 1405 may selectively be a storage device independent of the processing component 1401 described above. The image processing device 1400 may also include various sensors.

In an example, the input/output interface 1404 may receive an image or video to be segmented.

In an example, the processing component 1401 may perform feature extraction to obtain an image feature of an image or video to be segmented, generate a depth-aware feature based on the image feature, and obtain a segmentation result based on the depth-aware feature and a depth-aware representation. For example, the processing component 1401 may obtain the segmentation result of the image or video by performing a relational operation on the depth-aware feature and the depth-aware representation.

In an example, a neural network used for implementing the image processing function described herein may be trained on the image processing device 1400, or a neural network trained to implement the image processing function described herein may be received from the outside to process the image or video.

The image processing device 1400 is not limited to the configuration as illustrated in FIG. 14 but may include more components or fewer components, or examples of the image processing device 1400 may include a combination of specific components or another arrangement of the components.

In an example, the memory 1405, as a storage medium, may include an operating system (OS) (e.g., MAC OS), a data storage device, a network communication device, a user interface device, and a program and database (DB) related to the image processing method and/or training method described herein.

In an example, the network interface 1403 may be used for data communication with an external device/terminal, the input/output interface 1404 may be used for data interaction with a user, and the processing component 1401 and the memory 1405 may be disposed in the image processing device 1400. In an example, the image processing device 1400 may execute the image processing method provided herein through the processing component 1401 by calling various application programming interfaces (APIs) provided by the program and the OS that implement the image processing method stored in the memory 1405.

The processing component 1401 may include at least one processor having a set of computer-executable instructions stored in the memory 1405, and when the set of computer-executable instructions is executed by the at least one processor, may execute the image processing method described herein. In addition, the processing component 1401 may perform the image/video segmentation process described above. However, this is provided only as an example, and examples are not limited thereto.

For example, the image processing device 1400 may be a personal computer (PC), a tablet device, a personal digital assistant (PDA), a smartphone, or other devices capable of executing the instruction set. In this case, the image processing device 1400 may not necessarily be a single electronic device but may be a collection of devices or circuits that may individually or jointly execute the instruction set (or command set). The image processing device 1400 may also be part of an integrated control system or system manager or may be configured as a portable electronic device that interfaces locally or remotely (e.g., via wireless transmission).

In the image processing device 140, the processing component 1401 may be configured to execute programs or applications to configure the processor 1401 to control the image processing device 1400 to perform one or more or all operations and/or methods involving depth-aware feature generation, for example, and may include any one or a combination of two or more of, for example, a central processing unit (CPU), a graphic processing unit (GPU), a neural processing unit (NPU) and tensor processing units (TPUs), but is not limited to the above-described examples.

The processing component 1401 may execute instructions or code stored in the memory 1405. The memory 1405 may include computer-readable instructions. The processor 1401 may be configured to execute computer-readable instructions, such as those stored in the memory 1405, and through execution of the computer-readable instructions, the processor 1401 is configured to perform one or more, or any combination, of the operations and/or methods described herein. The memory 1405 may be a volatile or nonvolatile memory. The instructions and the data may also be transmitted and received over a network via the network interface 1403, for which any known transmission protocol may be used. In this case, the network interface 1403 may use any known transmission protocol.

The memory 1405 may be integrated with a processor, as RAM or flash memory is arranged within an integrated circuit microprocessor, for example. In addition, the memory 1405 may include an independent device such as an external disk drive, a storage array, or other storage devices that may be used in any DB system. The memory and the processor may be operatively connected or communicate with each other through an input/output port, a network connection, and the like, allowing the processor to read files stored in the memory.

FIG. 15 illustrates an example electronic device according to one or more embodiments.

Referring to FIG. 15, in an example, an electronic device 1500 may include one or more memories 1502 and one or more processors 1501. The one or more memories 1502 may store a set of computer-executable instructions. When the set of computer-executable instructions is executed by the one or more processors 1501, the electronic device 1500 may execute the image processing method described herein.

In an example, the one or more processors 1501 may each include a CPU, an audio/video processing unit, a programmable logic device, a dedicated processor system, a microcontroller, or a microprocessor. The one or more processors 1501 may further include, as non-limiting examples, an analog processor, a digital processor, a microprocessor, a multicore processor, a processor array, and a network processor.

The one or more memories 1502, as a storage medium, may include an OS (e.g., MAC OS), a data storage device, a network communication device, a user interface device, and a DB.

The one or more memories 1502 may be integrated with a processor, as RAM or flash memory is arranged within an integrated circuit microprocessor, for example. In addition, the one or more memories 1502 may include an independent device such as an external disk drive, a storage array, or other storage devices that may be used in any DB system. The one or more memories 1502 and the one or more processors 1501 may be operatively connected or communicate with each other through an input/output port, a network connection, and the like, allowing the one or more processors 1501 to read a file stored in the one or more memories 1502.

The one or more processors 1501 may execute computer-executable instructions stored in the one or more memories 1502 to extract a feature from an obtained image, obtain an image feature of the image, generate a depth-aware feature of the image based on the image feature, and obtain a segmentation result of the image based on the depth-aware feature and a depth-aware representation. In an example, the one or more processors 1501 may perform the image processing method as described above with reference to FIG. 3.

The electronic device 1500 may further include a video display (e.g., LCD) and a user interaction interface (e.g., keyboard, mouse, touch input device, etc.). All the components of the electronic device 1500 may be connected to each other through a bus and/or network.

The electronic device 1500 may be, for example, a PC, a tablet device, a PDA, a smartphone, or other devices capable of executing the instruction set described above. In this case, the electronic device 1500 may not necessarily be a single electronic device but may be a collection of devices or circuits that may individually or jointly execute the instruction set (or a command set). The electronic device 1500 may also be part of an integrated control system or system manager or may be configured as a portable electronic device that interfaces locally or remotely (e.g., via wireless transmission).

In addition, the electronic device 1500 is not limited to the configuration shown in FIG. 15 but may include, in an example, more components or fewer components or include a combination of specific components or another arrangement of the components.

At least one of the plurality of models described herein may be implemented through an artificial intelligence (AI) model. AI-related functions may be performed by a non-volatile memory, a volatile memory, and a processor.

In this case, the processor may include one or more processors. The one or more processors may be a general-purpose processor (e.g., a CPU, an application processor (AP), etc.) or a pure GPU (e.g., a GPU, a visual processing unit (VPU)), and/or an AI-specific processor (e.g., a neural processing unit (NPU)).

In an example, the one or more processors may control the processing of input data according to predefined operation rules or AI models stored in a non-volatile memory and a volatile memory, or may provide predefined operation rules or AI models through training or learning. In this case, the providing by training or learning may be applying a learning algorithm to a plurality of learning data to obtain an AI model with predefined operation rules or desired characteristics. This learning may be performed on a device itself in which AI according to the embodiment is performed, and/or may be implemented by a separate server/system.

The learning algorithm may be a method of training a predetermined target device (e.g., a robot) using a plurality of learning data, and inducing, allowing, or controlling the target device for determination or prediction. Example learning algorithms may include, but are not limited to, supervised learning, unsupervised learning, semi-supervised learning, or reinforcement learning.

An AI model may be obtained through training or learning. In this case, “obtaining the AI model through training or learning” may indicate that a basic AI model is trained with a plurality of learning data through a learning algorithm, a predefined operating rule or AI model is obtained, and the operating rule or AI model has desired characteristics (or intents).

For example, the AI model may include a plurality of neural network layers. Each of the layers may have a plurality of weight values, and the calculation of one layer may be performed based on a calculation result obtained from a previous layer and on a plurality of weights of a current layer. The neural network may include, as non-limiting examples, a convolutional neural network (CNN), a deep neural network (DNN), a recurrent neural network (RNN), a restricted Boltzmann machine (RBM), a deep belief network (DBN), a bidirectional recurrent deep neural network (BRDNN), and a generative adversarial network (GAN), and a deep Q network.

The electronic devices, neural networks, processors, memories, feature extraction model 401, depth-aware feature extraction model 402, depth-aware decoder 403, time domain slot attention model 404, depth estimator 503, depth feature extractor 501, visual feature extractor 502, depth-aware feature model 504, bin-level model 720, meter-level model 730, representation refinement model 801, depth estimation head 802, depth enhancement model 803, segmentation estimation head 804, bin-level enhancement model 1320, meter-level enhancement model 1330, processing component 1401, memory 1405, one or more memories memory 1502, and at least one or more processors 1501, described herein and disclosed herein described with respect to FIGS. 1-15 are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-15 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD−Rs, CD+Rs, CD−RWs, CD+RWs, DVD-ROMs, DVD−Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method, the method comprising:
generating a depth-aware feature of an image dependent on image features extracted from image data of the image; and
generating image data, representing information corresponding to one or more segmentations of the image, based on the depth-aware feature and a depth-aware representation,
wherein the depth-aware representation comprises depth-related information and visual-related information for the image.

2. The method of claim 1, wherein the generating of the depth-aware feature of the image comprises:
generating a visual feature and a depth feature of the image based on the image features; and
generating the depth-aware feature by fusing the visual feature and the depth feature.

3. The method of claim 2, wherein the generating of the depth-aware feature by fusing the visual feature and the depth feature comprises:
generating a first visual feature and a first depth feature by performing a convolution operation on the visual feature and the depth feature, respectively;
generating a first feature by fusing the first visual feature and the first depth feature;
generating a second feature by fusing the first depth feature and the first feature; and
generating the depth-aware feature by sequentially performing feature concatenation and feature transformation on the second feature and the visual feature.

4. The method of claim 3, wherein the generating of the depth-aware feature by sequentially performing the feature concatenation and the feature transformation comprises:
generating a third feature by sequentially performing feature concatenation and feature transformation on the second feature and the visual feature;
generating a fourth feature by reshaping a dimension of the depth feature;
generating a first depth position feature by fusing the fourth feature and a depth-related position embedding; and
generating the depth-aware feature by fusing the third feature and the first depth position feature.

5. The method of claim 1, wherein the generating of the image data comprises:
generating a refined depth-aware representation by refining the depth-aware representation;
generating depth prediction information of the segmentations based on the refined depth-aware representation and the depth-aware feature;
generating an enhanced depth-aware feature by enhancing the depth-aware feature; and
generating, as the image data, mask prediction information and category prediction information respectfully dependent on the refined depth-aware representation and the enhanced depth-aware feature.

6. The method of claim 5, wherein the generating of the refined depth-aware representation by refining the depth-aware representation comprises:
generating a first depth-aware representation by processing the depth-aware representation through a first attention network;
generating a second depth-aware representation by fusing the depth-aware representation and the first depth-aware representation and normalizing a feature-fused representation obtained by the fusing;
generating a third depth-aware representation by processing the depth-aware feature and the second depth-aware representation through a second attention network;
generating a fourth depth-aware representation by fusing the second depth-aware representation and the third depth-aware representation and normalizing a feature-fused representation obtained by the fusing; and
generating the refined depth-aware representation based on the fourth depth-aware representation using a feedforward network.

7. The method of claim 5, wherein the generating of the depth prediction information of the segmentations comprises:
generating a fifth feature by performing a linear operation on the refined depth-aware representation and obtaining a sixth feature by performing a convolution operation on the depth-aware feature;
generating a seventh feature by fusing the fifth feature and the sixth feature;
generating an eighth feature by fusing the seventh feature and the fifth feature;
generating a ninth feature by fusing the eighth feature and the sixth feature; and
generating the depth prediction information based on the ninth feature using a depth estimation network.

8. The method of claim 7, wherein the generating of the depth prediction information based on the ninth feature comprises:
generating a feature weight corresponding to the ninth feature by performing pooling on the ninth feature and performing a linear operation on a pooled ninth feature obtained by the pooling; and
generating the depth prediction information by performing a linear operation on the ninth feature using the feature weight.

9. The method of claim 5, wherein the generating of the depth prediction information of the segmentations comprises:
generating the depth prediction information and enhanced depth-related information of the segmentations based on the refined depth-aware representation and the depth-aware feature,
wherein the generating of the enhanced depth-aware feature comprises:
generating a tenth feature by performing a convolution operation on the depth-aware feature and obtaining an 11th feature by performing a convolution operation on the enhanced depth-related information;
generating a 12th feature by fusing the tenth feature and the 11th feature;
generating a 13th feature by fusing the 11th feature and the 12th feature; and
generating the enhanced depth-aware feature by sequentially performing feature concatenation and feature transformation on the 13th feature and the depth-aware feature.

10. The method of claim 9, wherein the generating of the enhanced depth-aware feature by sequentially performing the feature concatenation and the feature transformation on the 13th feature and the depth-aware feature comprises:
generating a 14th feature by sequentially performing feature concatenation and feature transformation on the 13th feature and the depth-aware feature;
generating a 15th feature by reshaping a dimension of the enhanced depth-related information;
generating a second depth position feature by fusing the 15th feature and a depth-related position embedding; and
generating the enhanced depth-aware feature by fusing the 14th feature and the second depth position feature.

11. The method of claim 5, wherein the generating of the mask prediction information and the category prediction information of the segmentations comprises:
generating the category prediction information based on the refined depth-aware representation using a first linear layer; and
generating a 16th feature associated with a mask and generating the mask prediction information by fusing the 16th feature and the enhanced depth-aware feature, based on the refined depth-aware representation, using a second linear layer.

12. The method of claim 5, wherein the image is a current frame image of a video to be processed, and
wherein the method further comprises:
generating a refined depth-aware representation of a previous frame image of the current frame image; and
performing similarity matching between a refined depth-aware representation of the current frame image and the refined depth-aware representation of the previous frame image, such that a same instance of the current frame image and the previous frame image have a unified indicator.

13. The method of claim 5, wherein the image is a current frame image of a video to be processed, and
wherein the method further comprises:
generating a refined depth-aware representation of a previous frame image of the current frame image; and
processing, through a third attention network, a refined depth-aware representation of the current frame image and the refined depth-aware representation of the previous frame image;
generating a time-domain refined depth-aware representation of a time-domain context; and
determining time-domain refined depth-aware representation as the refined depth-aware representation of the current frame image.

14. The method of claim 1, wherein one vector of the depth-aware representation represents one object in the image.

15. A non-transitory computer-readable storage medium storing instructions that, when executed by a processor, cause the processor to perform the image processing method of claim 1.

16. An electronic device, comprising:
processors configured to execute instructions; and
a memory storing the instructions, wherein execution of the instructions configures the processors to:
generate a depth-aware feature of an image dependent on image features extracted from image data of the image; and
generate image data, representing information corresponding to one or more segmentations of the image, based on the depth-aware feature and a depth-aware representation,
wherein the depth-aware representation comprises depth-related information and visual-related information for the image.

17. The electronic device of claim 16, wherein the processors are further configured to, when generating the depth-aware feature
generate a visual feature and a depth feature of the image based on the image features; and
generate the depth-aware feature by fusing the visual feature and the depth feature.

18. The electronic device of claim 17, wherein the processors are configured to, when obtaining the depth-aware feature by fusing the visual feature and the depth feature:
generate a first visual feature and a first depth feature by performing a convolution operation on the visual feature and the depth feature, respectively;
generate a first feature by fusing the first visual feature and the first depth feature;
generate a second feature by fusing the first depth feature and the first feature; and
generate the depth-aware feature by sequentially performing feature concatenation and feature transformation on the second feature and the visual feature.

19. The electronic device of claim 18, wherein the processors are configured to, when generating the depth-aware feature:
generate a third feature by sequentially performing feature concatenation and feature transformation on the second feature and the visual feature;
generate a fourth feature by reshaping a dimension of the depth feature;
generate a first depth position feature by fusing the fourth feature and a depth-related position embedding; and
generate the depth-aware feature by fusing the third feature and the first depth position feature.

20. The electronic device of claim 16, wherein the processors are further configured to, when generating the segmentations
generate a refined depth-aware representation by refining the depth-aware representation;
generate depth prediction information of the segmentations based on the refined depth-aware representation and the depth-aware feature;
generate an enhanced depth-aware feature by enhancing the depth-aware feature; and
generate mask prediction information and category prediction information of the segmentations based on the refined depth-aware representation and the enhanced depth-aware feature.
